(19) United States
(12) Patent Application Publication
(10) Pub. No.: US 2025/0229681 A1
(43) Pub. Date: Jul. 17, 2025

(54) SEAT BACK

(71) Applicant: TOYOTA BOSHOKU KABUSHIKI KAISHA, Aichi-ken (JP)

(72) Inventors: Hiroki UMEMURA, Kasugai-shi (JP); Machiko HAMAYA, Kasugai-shi (JP); Mayu TAKAHASHI, Toyohashi-shi (JP); Tetsuo NAKAGAWA, Nagakute-shi (JP)

(73) Assignee: TOYOTA BOSHOKU KABUSHIKI KAISHA, Aichi-ken (JP)

(21) Appl. No.: 18/982,243

(22) Filed: Dec. 16, 2024

(30) Foreign Application Priority Data
Jan. 11, 2024 (JP) 2024-002368

(51) Int. Cl. B60N 2/64; B60N 2/58

(52) U.S. Cl. CPC B60N 2/643; B60N 2/58

(57) ABSTRACT

A seat back includes a back board, a back pad provided to be brought into contact with the back board, and a back cover to be placed over the back pad and the back board. The back board includes a peripheral edge projecting portion that projects to be bent from a peripheral edge of the back board toward the seat front side. The back pad includes a pad convex portion that bulges in a manner of projecting outward with respect to the peripheral edge projecting portion and that is to be brought into contact with the peripheral edge projecting portion from the seat front side, and the back cover is placed over the pad convex portion and the peripheral edge projecting portion in a manner that the back cover is pressed down to deform the bulging of the pad convex portion.

### CROSS REFERENCE TO RELATED APPLICATIONS

This application is based on Japanese Patent Applications No. 2024-002368 filed on Jan. 11, 2024, the entire contents of which are incorporated herein by reference.

### TECHNICAL FIELD

The present invention relates to a seat back. Specifically, the present invention relates to a seat back including a back board, a back pad provided to be brought into contact with the back board from a seat front side, and a back cover to be placed over the back pad and the back board.

### BACKGROUND ART

JP2006-281801A discloses a configuration in which a back board is provided on a back surface of a seat back. A back surface cover piece of a back cover covering a surface of the seat back is placed over a back surface of the back board.

In the configuration described in JP2006-281801A, a step is likely to occur at a joint portion between the back board and a back pad provided on a surface of the back board due to deformation of the back pad. Therefore, the back cover placed over these surfaces is prone to having meandering of a highlight line or a seam line due to the step. In view of the above, the present invention provides a seat back capable of reducing a step that may occur at a joint portion between a back board and a back pad.

### SUMMARY OF INVENTION

To solve the above problems, a seat back according to the present invention is configured as follows.

[1] According to an aspect of the present invention, a seat back includes a back board, a back pad provided to be brought into contact with the back board from a seat front side, and a back cover to be placed over the back pad and the back board. In the seat back, the back board includes a peripheral edge projecting portion that projects to be bent from a peripheral edge of the back board toward the seat front side, in a state where the back cover is not placed over the back pad and the back board, the back pad includes a pad convex portion that bulges in a manner of projecting outward with respect to the peripheral edge projecting portion and that is to be brought into contact with the peripheral edge projecting portion from the seat front side, and in a state where the back cover is placed over the back pad and the back board, the back cover is placed over the pad convex portion and the peripheral edge projecting portion in a manner that the back cover is pressed down to deform the bulging of the pad convex portion.

According to the first aspect of the present invention, the amount by which the pad convex portion is deformed due to the stretching of the back cover can be kept at a position at which the back cover is pressed against and engaged with the peripheral edge projecting portion of the back board. As a result, it is possible to reduce a step that may occur at a joint portion between the pad convex portion after being deformed and the peripheral edge projecting portion of the back board. Accordingly, the back cover can be appropriately stretched.

[2] In the seat back according to [1], the back board further includes a back supporting portion that projects toward the seat front side to support the pad convex portion from an inner side in a bulging direction.

According to the second aspect of the present invention, the pad convex portion can be supported from back so as not to be excessively pressed down by a load applied from the outside or a stretching force of the back cover. Accordingly, it is possible to more appropriately reduce the step that may occur at the joint portion between the pad convex portion and the peripheral edge projecting portion of the back board.

[3] In the seat back according to [1], the peripheral edge of the back board on which the peripheral edge projecting portion is formed is an upper edge of the back board.

According to the third aspect of the present invention, the upper edge portion of the seat back, which is easily visible to a user, can be finished with a good appearance.

[4] In the seat back according to [1], the peripheral edge projecting portion of the back board is bent to curve toward the seat front side.

According to the fourth aspect of the present invention, a highlight line that deteriorates the appearance can be prevented from appearing in a portion of the back cover that is placed over the peripheral edge of the back board.

### BRIEF DESCRIPTION OF DRAWINGS

FIG. 1 is a perspective view illustrating a schematic configuration of a seat back according to a first embodiment;

FIG. 2 is a rear view of the seat back;

FIG. 3 is a cross-sectional view taken along a line III-III in FIG. 2; and

FIG. 4 is a cross-sectional view corresponding to FIG. 3, illustrating a state before a back cover is stretched.

### DESCRIPTION OF EMBODIMENTS

Hereinafter, an embodiment of the present invention will be described with reference to the drawings.

### First Embodiment

### (Schematic Configuration of Seat Back 1)

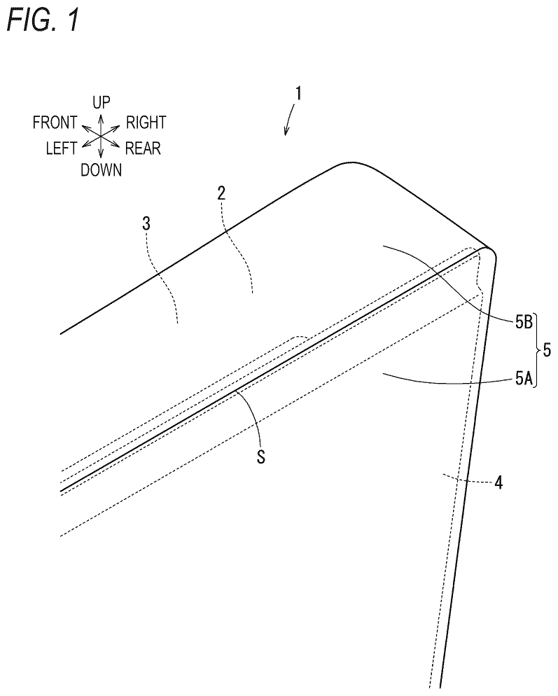

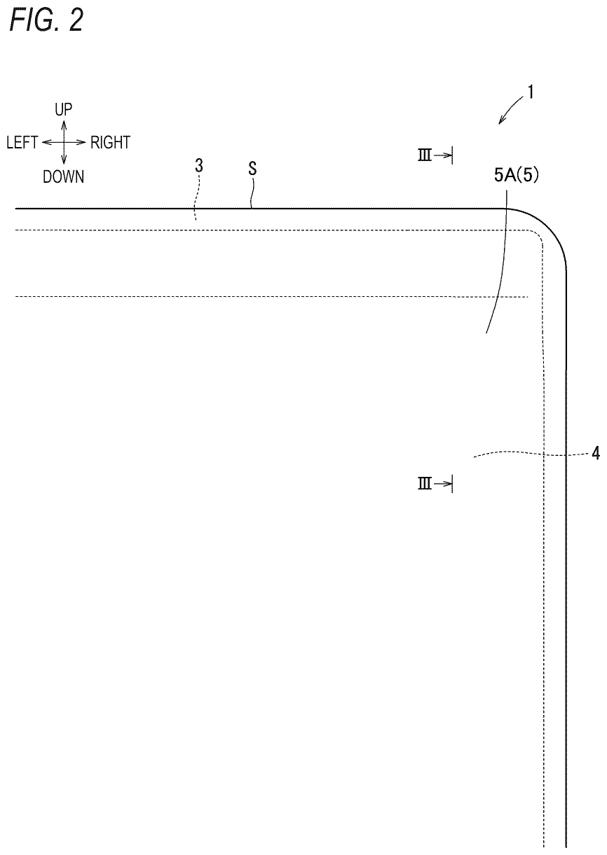

First, a configuration of a seat back 1 according to a first embodiment of the present invention will be described with reference to FIGS. 1 to 4. In the following description, when a direction such as front, rear, up, down, left, or right is described, it is assumed that the direction indicates a corresponding direction illustrated in the drawings.

When combinations of the directions with a word “seat” are described such as a “seat width direction”, the combinations indicate directions based on the seat back 1. In addition, in the following description, when a specific reference diagram is not described or when there is no corresponding reference numeral in the reference diagram, any one of FIGS. 1 to 4 is referred to as appropriate.

As illustrated in FIGS. 1 to 3, the seat back 1 according to the present embodiment is implemented as a backrest of a rear seat that forms a seat in a last low of an automobile. The seat back 1 includes a metal back frame 2 that forms a framework of the seat back 1, and a back pad 3 that is made of foamed urethane and is to be placed over a front portion of the back frame 2.

The seat back 1 includes a flat back board 4 made of resin and provided on a back surface of the seat back 1, and a back cover 5 to be placed over an entire surface of the seat back 1. The back board 4 is attached to the back frame 2 from a back surface side, and forms a substantially flat hard surface on the back surface of the seat back 1. The back frame 2 is assembled in a frame shape in a front view.

The back pad 3 is assembled to be placed over, from a front side, the back frame 2 having a frame shape in a front view. The back pad 3 is pulled rearward in a manner that upper, lower, left and right peripheral edge portions of the back pad 3 wrap frame sides of the back frame 2 from an outer peripheral side. Accordingly, each peripheral edge portion of the back pad 3 is set to be brought into contact with the back board 4 from the front side (a seat front side) due to stretching of the back cover 5 that is placed over the surface of the back pad 3.

The back cover 5 has a bag shape including a back surface cover portion 5A placed over the back surface of the seat back 1, and a side cover portion 5B placed over a front surface and each of upper, lower, left, and right surfaces of the seat back 1 except for the back surface. The back surface cover portion 5A is made of a single piece of carpet material. The side cover portion 5B is implemented by connecting a plurality of cover pieces that are made of a fabric material and are cut in accordance with shapes of the respective surfaces of the seat back 1 except for the back surface. The side cover portion 5B is softer than the back surface cover portion 5A.

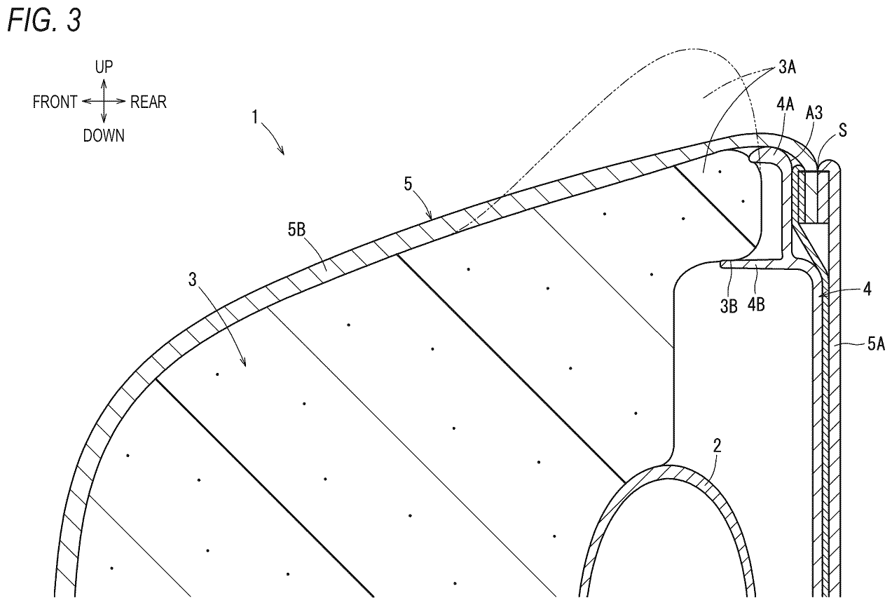

The side cover portion 5B and the back surface cover portion 5A are connected to each other by sewing upper edges of the side cover portion 5B and the back surface cover portion 5A together (see a seam line S illustrated in FIG. 3). Respective side edges of the side cover portion 5B and the back surface cover portion 5A are connected to each other so as to be openable and closable by coupling of zip fasteners (not illustrated) provided along the respective edges.

The back cover 5 is set to be placed over the back frame 2, the back pad 3, and the back board 4 from above after the back board 4 and the back pad 3 are set on the back frame 2. After being placed over, spaces between the respective side edges of the side cover portion 5B and the back surface cover portion 5A of the back cover 5 are closed with zip fasteners (not illustrated).

Accordingly, the back cover 5 is closed in a bag shape, and the back surface cover portion 5A and the side cover portion 5B are stretched to be in close contact with the back board 4 and the back pad 3, respectively. With this stretching, the back pad 3 is positioned and fixed to be pressed against the back frame 2 and the back board 4 as illustrated in FIG. 3. A lower end of the side cover portion 5B of the back cover 5 is pulled rearward to wrap the back pad 3, and is fixed to be joined with a lower end of the back surface cover portion 5A.

When the back cover 5 is stretched, if a step occurs at a joint portion of the peripheral edge where the back pad 3 and the back board 4 are joined together, the seam line S for sewing the upper edges of the side cover portion 5B and the back surface cover portion 5A together is likely to meander. In addition, a highlight line is likely to appear on a surface of the back cover 5 due to a peripheral line of the highly rigid back board 4 standing out.

In order to cope with such problems, a structure is provided between the back pad 3 and the back board 4 to reduce the step that may occur at the joint portion. The respective side edges of the side cover portion 5B and the back surface cover portion 5A are coupled by zip fasteners (not illustrated) to provide a highly rigid structure, making such problems unlikely to occur.

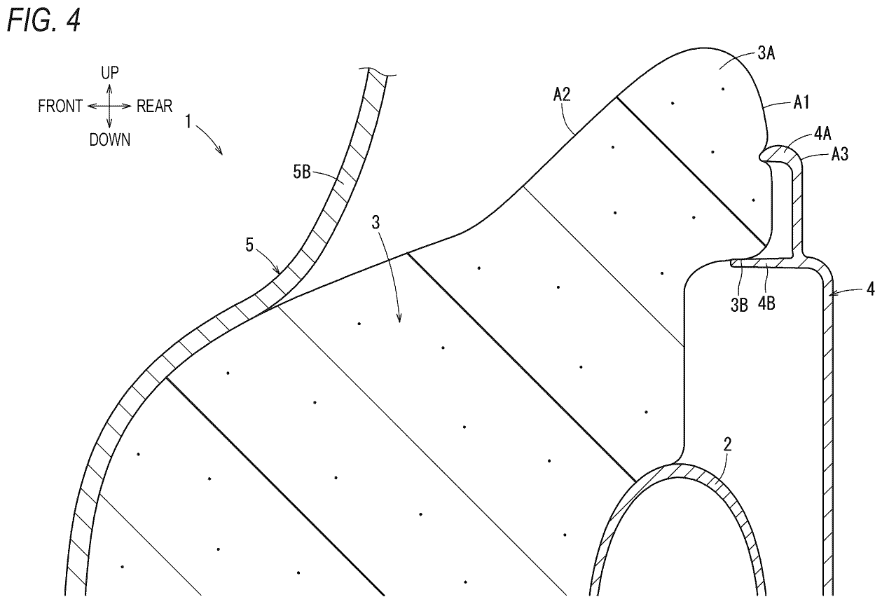

Hereinafter, a structure of the joint portion between the back pad 3 and the back board 4 will be described in detail. As illustrated in FIG. 4, an upper edge of the back board 4 is formed with a peripheral edge projecting portion 4A that projects to be bent toward the front side that is the seat front side. The peripheral edge projecting portion 4A is formed along the upper edge of the back board 4 so as to continuously extend with a uniform cross section over substantially the entire region in the seat width direction.

The peripheral edge projecting portion 4A does not project forward from the upper edge of the back board 4 in a bent shape, but projects in a curved shape to form a gentle curved surface A3 on an outer peripheral surface of a base portion. This makes it difficult for a highlight line that deteriorates an appearance to appear on the surface of the back cover 5 that is placed over the peripheral edges of the back board 4.

In an upper edge portion of the back pad 3, a portion to be brought into contact with the peripheral edge projecting portion 4A of the back board 4 from the front side is formed with a pad convex portion 3A that bulges upward so as to project outward with respect to the peripheral edge projecting portion 4A. The pad convex portion 3A is formed along the upper edge portion of the back pad 3 so as to continuously extend with a uniform cross section over substantially the entire region in the seat width direction.

The pad convex portion 3A has a shape in which a rear surface A1 facing the peripheral edge projecting portion 4A is rounded and rises upward so as to be slightly curved forward. An upper surface A2 of the pad convex portion 3A is a curved surface that is bent in a convex curved surface shape in a side view so as to gently descend forward. In this way, the pad convex portion 3A is formed in a shape that bulges in a substantially right triangular shape in a side view such that a rear side portion facing the peripheral edge projecting portion 4A bulges most and the bulging becomes smaller toward the front.

As illustrated in FIG. 3, due to stretching of the back cover 5 on a surface of the pad convex portion 3A, the pad convex portion 3A is pressed from above by the side cover portion 5B so as to be deformed downward. Specifically, as the back cover 5 is stretched to a position where the back cover 5 is pressed against and engaged with the peripheral edge projecting portion 4A of the back board 4, the pad convex portion 3A is pressed downward by the side cover portion 5B so as to be deformed to a position at substantially the same height as the peripheral edge projecting portion 4A.

At this time, the pad convex portion 3A is restricted so as to be deformed only to a position at substantially the same height as the peripheral edge projecting portion 4A by the maximum. This is because the back cover 5 presses the pad convex portion 3A downward only to a position where the back cover 5 is pressed against and engaged with the peripheral edge projecting portion 4A of the back board 4.

Accordingly, the pad convex portion 3A is actually deformed by a stretching force of the back cover 5 to a position at substantially the same height as the peripheral edge projecting portion 4A of the back board 4 or to a position slightly above the peripheral edge projecting portion 4A. As a result, it is possible to reduce a step that may occur at the joint portion between the pad convex portion 3A after being deformed and the peripheral edge projecting portion 4A of the back board 4. Accordingly, the back cover 5 can be appropriately stretched.

The back pad 3 has a shape in which a rear surface of a portion directly below the pad convex portion 3A is recessed forward with respect to the rear surface A1 of the pad convex portion 3A. The back board 4 is formed with a back supporting portion 4B that projects in a flat plate shape so as to come into surface contact with a seat portion 3B, which is an upper surface of the recess of the back pad 3, from below. The back supporting portion 4B projects from a front portion below the peripheral edge projecting portion 4A of the back board 4.

The seat portion 3B is formed to continuously extend with a uniform cross section over substantially the entire region of the back pad 3 except for both ends in the seat width direction. The back supporting portion 4B is also formed to continuously extend with a uniform cross section over substantially the entire region of the back board 4 except for both ends in the seat width direction.

The back supporting portion 4B supports the seat portion 3B of the back pad 3 from below, whereby the pad convex portion 3A is supported from a lower side which is an inner side in a bulging direction. Accordingly, the pad convex portion 3A can be supported from back so as not to be excessively pressed down by a load applied from the outside or the stretching force of the back cover 5. As a result, it is possible to more appropriately reduce the step that may occur at the joint portion between the pad convex portion 3A and the peripheral edge projecting portion 4A.

In summary, the seat back 1 according to the present embodiment has the following configuration. In the following description, reference numerals assigned in parentheses correspond to the configurations described in the embodiment described above.

That is, a seat back (1) includes: a back board (4); a back pad (3) provided to be brought into contact with the back board (4) from a seat front side; and a back cover (5) to be placed over the back pad (3) and the back board (4). The back board (4) includes a peripheral edge projecting portion (4A) that projects to be bent from a peripheral edge of the back board (4) toward the seat front side. The back pad (3) includes a pad convex portion (3A) that bulges in a manner of projecting outward with respect to the peripheral edge projecting portion (4A) and that is to be brought into contact with the peripheral edge projecting portion (4A) from the seat front side. The back cover (5) is to be placed over the pad convex portion (3A) and the peripheral edge projecting portion (4A) in a manner that the back cover (5) is pressed down to deform the bulging of the pad convex portion (3A).

According to the above configuration, the amount by which the pad convex portion (3A) is deformed due to the stretching of the back cover (5) can be kept at a position at which the back cover (5) is pressed against and engaged with the peripheral edge projecting portion (4A) of the back board (4). As a result, it is possible to reduce a step that may occur at the joint portion between the pad convex portion (3A) after being deformed and the peripheral edge projecting portion (4A) of the back board (4). Accordingly, the back cover (5) can be appropriately stretched.

The back board (4) further includes a back supporting portion (4B) that projects toward the seat front side to support the pad convex portion (3A) from an inner side in a bulging direction. According to the above configuration, the pad convex portion (3A) can be supported from back so as not to be excessively pressed down by a load applied from the outside or a stretching force of the back cover (5). Accordingly, it is possible to more appropriately reduce the step that may occur at the joint portion between the pad convex portion (3A) and the peripheral edge projecting portion (4A) of the back board (4).

The peripheral edge of the back board (4) on which the peripheral edge projecting portion (4A) is formed is an upper edge of the back board (4). According to the above configuration, the upper edge portion of the seat back, which is easily visible to a user, can be finished with a good appearance.

The peripheral edge projecting portion (4A) of the back board (4) is bent to curve toward the seat front side. According to the above configuration, a highlight line that deteriorates the appearance can be prevented from appearing in a portion of the back cover (5) that is placed over the peripheral edge of the back board (4).

### Other Embodiments

The embodiments according to the present invention have been described with reference to one embodiment, whereas the present invention can be implemented in various forms other than the above embodiment.

1. The seat back according to the present invention is applicable not only to a seat to be mounted on a vehicle such as an automobile or a railroad vehicle, but also to a seat to be mounted on other vehicles such as an aircraft or a ship. The seat back is also applicable to a seat 5 not to be mounted on a vehicle.

2. The peripheral edge where the peripheral edge projecting portion formed on the back board and the pad convex portion formed on the back pad are joined may be a portion corresponding to the side edge of the seat back in addition to the portion corresponding to the upper edge of the seat back. Further, the peripheral edge may be a portion corresponding to both the upper edge and the side edge of the seat back.

3. In the back cover, the back surface cover portion and the side cover portion may be made of the same material. The back cover may be made of leather material such as synthetic leather or natural leather.

What is claimed is:

1. A seat back comprising:
a back board;
a back pad provided to be brought into contact with the back board from a seat front side; and
a back cover to be placed over the back pad and the back board,
wherein the back board includes a peripheral edge projecting portion that projects to be bent from a peripheral edge of the back board toward the seat front side,
in a state where the back cover is not placed over the back pad and the back board, the back pad includes a pad convex portion that bulges in a manner of projecting outward with respect to the peripheral edge projecting portion and that is to be brought into contact with the peripheral edge projecting portion from the seat front side, and
in a state where the back cover is placed over the back pad and the back board, the back cover is placed over the pad convex portion and the peripheral edge projecting portion in a manner that the back cover is pressed down to deform the bulging of the pad convex portion.

2. The seat back according to claim 1, wherein
the back board further includes a back supporting portion that projects toward the seat front side to support the pad convex portion from an inner side in a bulging direction.

3. The seat back according to claim 1, wherein
the peripheral edge of the back board on which the peripheral edge projecting portion is formed is an upper edge of the back board.

4. The seat back according to claim 1, wherein
the peripheral edge projecting portion of the back board is bent to curve toward the seat front side.

5. The seat back according to claim 2, wherein
the peripheral edge of the back board on which the peripheral edge projecting portion is formed is an upper edge of the back board.

6. The seat back according to claim 2, wherein
the peripheral edge projecting portion of the back board is bent to curve toward the seat front side.
